(19) United States
(12) Patent Application Publication
(10) Pub. No.: US 2007/0114817 A1
(43) Pub. Date: May 24, 2007

(54) Raising mechanism for a sliding roof and vehicle roof comprising such raising mechanism

(76) Inventors: Thomas Becher, Rodgau (DE); Horst Boehm, Frankfurt (DE); Rainer Grimm, Frankfurt (DE); Claudia Riess, Lichtenberg (DE); Joachim Roeder, Muehlheim (DE); Manfred Roehnke, Roedermark (DE)

Correspondence Address: CARLSON, GASKEY & OLDS, P.C., 400 WEST MAPLE ROAD, SUITE 350, BIRMINGHAM, MI, 48009, US

(21) Appl. No.: 11/602,666

(22) Filed: Nov. 21, 2006

(30) Foreign Application Priority Data
Nov. 23, 2005 (EP) 05 025 513.2

(51) Int. Cl. B60J 7/043

(52) U.S. Cl. 296/216.03

(57) ABSTRACT

The invention relates to a raising mechanism for a sliding roof, comprising a guide rail, a pair of levers, and a carriage. Each lever has a guide rail side end and a cover side end, and the levers are pivotally coupled with each other through a joining axle. During traversing movement, the carriage exerts a vertical force on the joining axle and lifts the joining axle, in order to thereby move the pair of levers to a raised position. The invention further relates to a vehicle roof with such a raising mechanism.

### RELATED APPLICATIONS

The application claims priority to European Patent Application No. 05 025 513.2 which was filed on Nov. 23, 2005.

### BACKGROUND OF THE INVENTION

The invention relates to a raising mechanism for a sliding roof and further to a vehicle roof including this raising mechanism.

Sliding roofs have at least one cover that can fully or partially expose a roof opening, or assume a ventilation position by raising the cover at a rear end.

Known mechanisms use several carriages to raise and shift the cover, where each carriage can be shifted in one lateral guide rail. By the cooperation of the carriages and the lateral guide rails, a lifting motion is produced by which the corresponding cover can be shifted upwards, as well as producing a displacing motion. For this purpose slotted guides are usually used.

A disadvantage with these constructions is the relatively large installation volume of carriage arrangements in a longitudinal direction of the vehicle, as well as of the arrangement of the carriages, levers and guide rails in a vertical direction. Moreover, with a completely retracted cover, an opening width of the roof opening in the longitudinal direction of the vehicle is limited by a structural length of the carriages and levers, in particular in a situation where the cover is moved to lie above a roof sheet.

It is the object of the invention to provide a raising mechanism for a sliding roof, which has a simple construction, needs a small installation volume, and allows a large opening width, as well as to provide a vehicle roof with such a raising mechanism.

### SUMMARY OF THE INVENTION

To this end the invention makes provision for a raising mechanism for a sliding roof. The raising mechanism includes at least one laterally arranged guide rail, and two levers constituting a pair of levers, with each of the levers having a guide rail side end and a cover side end, and where both levers are pivotally coupled with each other through a joining axle. The raising mechanism also includes a carriage which, during traversing, exerts a vertical force on the joining axle and lifts the joining axle in order to thereby move the pair of levers to a raised position. A mechanism, e.g. a cable that is guided so as to be resistant to buckling, can be shifted by a drive motor that engages the carriage, so that the latter is displaced along a guide rail. During traversing, the carriage exerts a vertical force on the joining axle, so that the pair of levers (coupled to each other through this joining axle) arrive at the raised position. In this process, the vertical force advantageously directly engages the joining axle. To raise the cover, only one carriage is needed whereby a small installation volume is required in the longitudinal direction of the vehicle, which results in a positive effect on an opening width of an associated roof opening.

It is preferred that a bolt defines the joining axle.

The joining axle is arranged in particular on a first lever, and is non-rotatably fixed to the first lever, for instance.

A second lever may have a curved elongated hole that is engaged by the joining axle, which permits a raising and lowering of the second lever during shifting of the carriage by forming a slotted guide between the first and second levers.

According to a preferred embodiment, the carriage has a slot that is engaged by the bolt. It would be likewise possible to provide an intermediate part that has a slot, and which is attached to the carriage with the joining axle engaging with the slot.

In order to hold the raising mechanism securely in a position in the closed condition of the sliding roof, a position fixing mechanism is provided on a vehicle side end of one lever, and is adapted to be selectively coupled with a vehicle-fixed part, in particular with the guide rail. In a coupled state, the associated lever and the raising mechanism cannot be shifted, or can be shifted only by a minor amount. As already explained, the vehicle side end of the lever and the entire raising mechanism are temporarily fixed in their position by the position fixing mechanism (at least in the closed position).

The position fixing mechanism is uncoupled from the carriage or coupled to the carriage by a coupling mechanism for movement together with the carriage and to be able to engage with the vehicle-fixed part, respectively.

The coupling mechanism preferably has a coupling pin and a coupling slot.

According to one embodiment, the coupling pin is associated to a first lever of the pair of levers and the coupling slot is provided on the carriage. Particularly during raising of the cover for further exposure the roof opening, the coupling slot engages with the coupling pin of the first lever, with the first lever being coupled to the carriage and moved by the latter along the guide rail together with a second lever of the pair of levers.

The coupling pin preferably is connected with one lever of the pair of levers through a leaf spring. When the cover is closed, as well as when in the ventilation position, the coupling pin is in a recess of the guide rail. When the carriage is moved, the coupling slot on the carriage engages with the coupling pin and moves the coupling pin out of the recess, i.e. releases the coupling pin. During a further movement of the carriage, both levers will be moved; and during closing of the cover, the coupling pin is urged by the leaf spring to engage with the recess of the guide rail, to fix the raising mechanism and the cover in their positions.

It is preferred that each lever has a cover side end provided with a fork-like portion that engages with the cover. The fork-like portion and a rib that is attached to the cover, for example, have an opening that may be engaged by a pin so that both levers are firmly fixed to the cover in an articulating manner. As an alternative, it would also be conceivable to screw the cover to the levers.

It is possible that each lever has a guide element at a guide rail side end, with each guide element being shiftable in the guide rail. The levers are supported on the guide rail by the guide elements.

The sliding roof is in particular a spoiler roof. With a spoiler roof, the cover is displaced to lie above a stationary roof part of the vehicle roof. The sliding roof could also be a sliding-tilting roof in which the cover is displaced to lie underneath the stationary roof part.

The invention further relates to a vehicle roof comprising a raising mechanism according to the invention, with a roof opening being provided that can be opened and closed by a cover, and which has a longitudinal side along which the carriage is moved during exposing and closing the roof opening. The carriage is moved only between edges that extend transverse to a longitudinal axis. Thus, the carriage is moved along those edges of the roof opening that are parallel to the longitudinal axis of the vehicle, and only across the length of these edges, i.e. the carriage is not displaced to lie underneath the stationary roof part that surrounds the roof opening.

It will be preferred that the carriage substantially lies within the roof opening which is limited by a surrounding edge to allow an installation of the complete spoiler roof unit from the top. This results in increased headroom for an occupant.

According to a preferred embodiment, the guide rail also lies within the roof opening that is limited by a surrounding edge. This likewise enlarges the headroom for the vehicle occupant.

These and other features of the present invention can be best understood from the following specification and drawings, the following of which is a brief description.

### BRIEF DESCRIPTION OF THE DRAWINGS

FIG. 1 is a schematic perspective view of a vehicle roof according to the invention, including a raising mechanism, according to the invention, for a sliding roof.

FIG. 2 is a schematic view of the vehicle roof according to the invention, including the raising mechanism according to the invention, with a cover being in a closed position.

FIG. 3 is a schematic view of the vehicle roof with the raising mechanism according to FIG. 2 and without a carriage.

FIG. 4 is a schematic view of the vehicle roof with the raising mechanism and with the cover being in a ventilation position.

FIG. 5 is a schematic view of the vehicle roof with the raising mechanism according to FIG. 4 and without the carriage.

FIG. 6 is a schematic view of the vehicle roof with the raising mechanism and with the cover being in an opened position.

FIG. 7 is a perspective partial view of the raising mechanism according to the invention for the cover in the ventilation position.

FIG. 8 is a basic draft of a side view of the raising mechanism according to FIG. 7.

FIG. 9 is a perspective view of the carriage of the raising mechanism according to the invention.

FIG. 10 is a perspective view of a lever of the raising mechanism according to FIG. 7.

FIG. 11 is a perspective view of the carriage and the lever of the raising mechanism according to the invention.

FIG. 12 is a perspective view of the carriage and the lever of the raising mechanism according to the invention.

### DETAILED DESCRIPTION OF THE PREFERRED EMBODIMENT

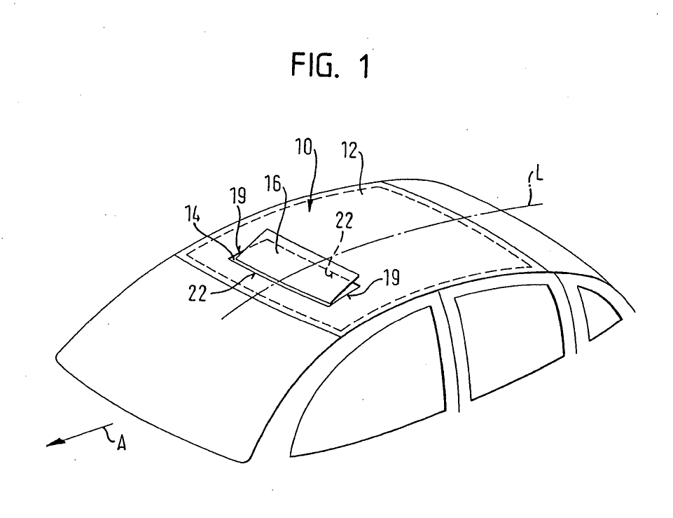

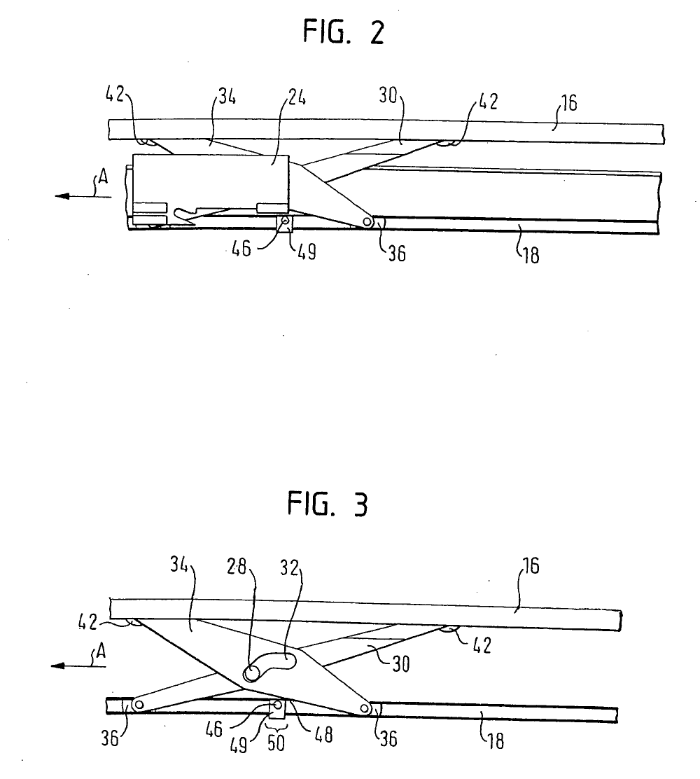

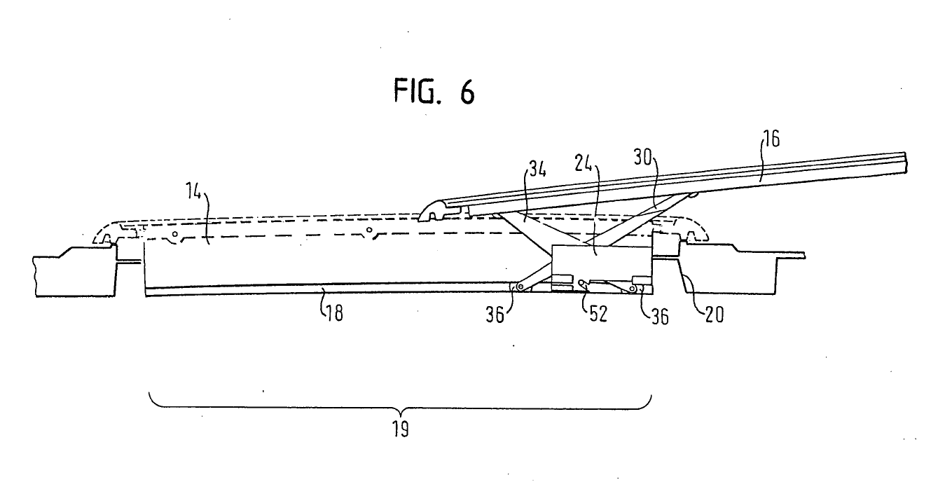

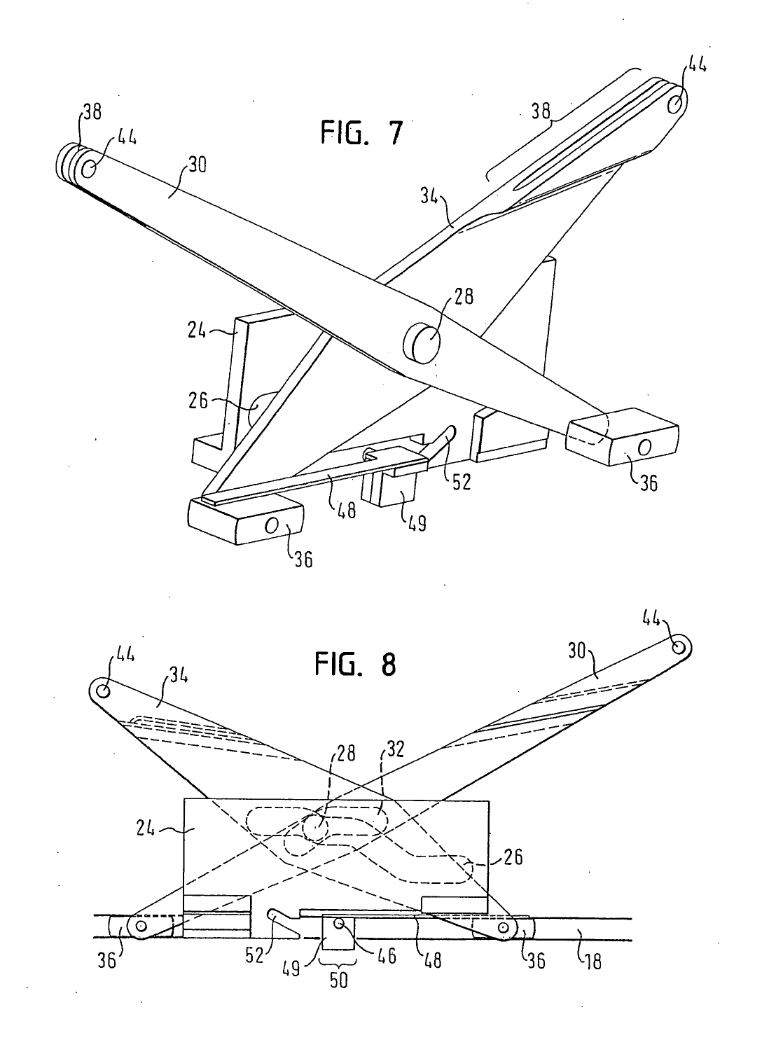

FIG. 1 schematically shows a vehicle roof 10 comprising a stationary roof part 12 in which a roof opening 14 is provided that can be closed (FIGS. 2 and 3) or exposed (FIG. 6) by a cover 16 made of a visually transparent or an opaque material. In FIGS. 1, 4 and 5, the cover 16 is shown in a ventilation position in which the cover 16 is raised at a rear end.

The presented vehicle roof 10 is a sliding roof, in particular a spoiler roof, in which the cover 16 is moved to lie above the stationary roof part 12. The vehicle roof 10 could also be implemented such that the vehicle roof 10 includes a sliding-tilting roof; in that case (not shown) the cover 16 would be moved to lie underneath the stationary roof part 12.

On two longitudinal sides 19 of the roof opening 14, a raising mechanism for the cover 16 has one guide rail 18 each (FIGS. 1 to 6), which are fastened to the stationary roof part 12 surrounding the roof opening 14. The guide rails 18 extend along the longitudinal sides 19 of the roof opening 14, which run parallel to the longitudinal axis L of the vehicle. The guide rails 18 are only provided between those edges 22 of the roof opening 14 which run transverse to the longitudinal axis L of the vehicle (see in particular FIG. 6).

In this arrangement, the guide rails 18 do not protrude into an interior space of the vehicle, as can be seen in particular in FIG. 6. Instead, the guide rails 18 are vertically provided in a zone of a surrounding edge 20 limiting the roof opening 14 and surrounding the latter. This allows an installation of the spoiler roof unit from the top, as well as providing increased headroom for a vehicle occupant.

A carriage 24 is movably attached in each guide rail 18; a shifting mechanism (not shown), for instance a drive cable that is guided to be resistant to buckling and adapted to be shifted by a drive motor in a known manner, engages with the carriage 24. In this way the carriage 24 can be moved in translation along the guide rail 18; in doing so, the carriage 24 will not be moved to lie underneath the stationary roof part 12 owing to the position of the guide rail 18.

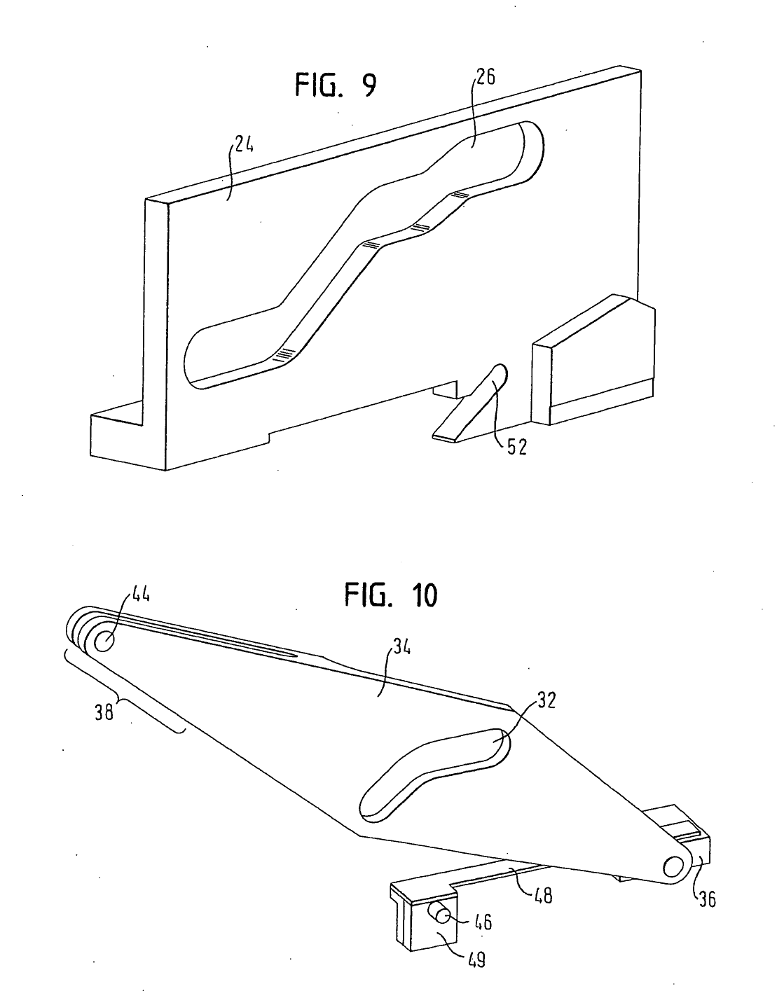

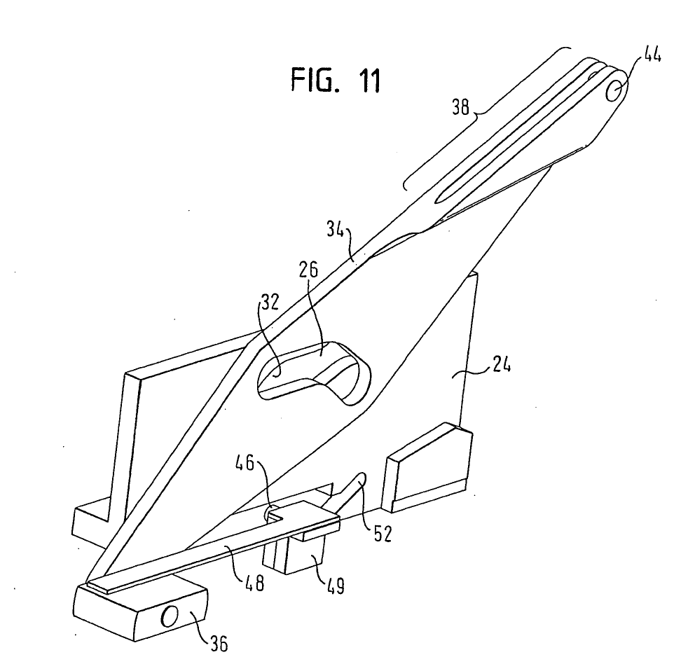

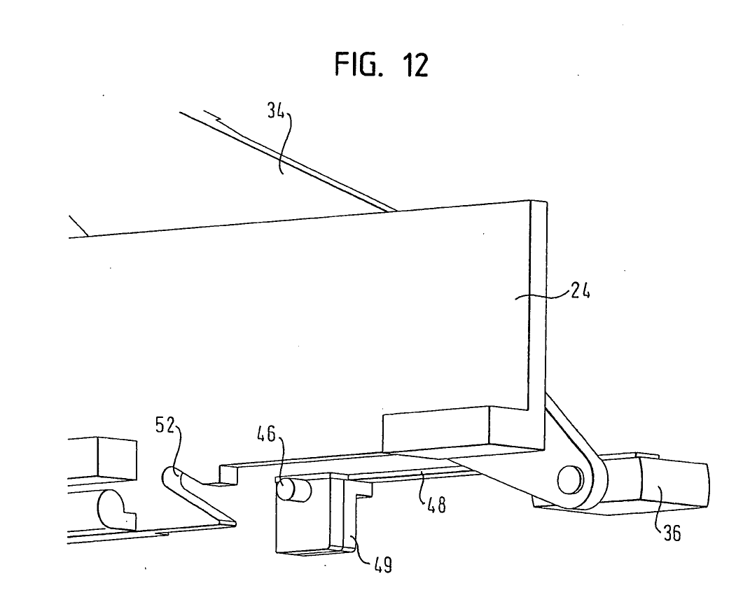

A slot 26 (FIGS. 8 and 9) is formed on a side of the carriage 24 that faces away from the longitudinal side 19 of the roof opening 14. As seen in the direction of travel A (FIGS. 2-5), the slot 26 first extends parallel to the direction of the guide rail 18, then downwards by a short distance, again parallel to the direction of the guide rail 18, then extends so as to further descend obliquely, and finally again extends parallel to the guide rail 18.

Apart from the guide rail 18 and the carriage 24, the raising mechanism comprises first and second levers 30, 34 that define a scissor type linkage. The slot 26 is engaged by a joining axle 28 in the form of a bolt, this joining axle 28 being non-rotatably attached to the first lever 30. The joining axle 28 passes through a curved elongated hole 32 of the second lever 34 and pivotally couples the first and second levers 30, 34 with each other. As the joining axle 28 engages with the slot 26, the carriage 24 exerts a vertical force directly on the first and second levers 30, 34 when the carriage 24 moves.

Both the first and second levers 30, 34 have a guide rail side end pivotally attached to a guide element 36 (sliding piece), with each guide element 36 being movable in the guide rail 18. The first and second levers 30, 34 are coupled to each other in the manner of a pair of scissors. The guide element 36 of the first lever 30, which carries the joining axle 28, lies ahead of the guide element 36 of the second lever 34 in the direction of travel A.

On a cover side, end the first and second levers 30, 34 each have a fork-like portion 38 that engages with a respective rib 42 of the cover 16. The first and second levers 30, 34 are pivotally fastened to the cover 16 by a pin 44 or screw.

So that the raising mechanism is fixed in its position when the cover 16 is closed, a position fixing mechanism is provided on the guide rail side end of the second lever 34, which firmly positions an end of the second lever 34 in the lifted and closed positions, and also firmly positions the entire raising mechanism temporarily (namely in the closed position of the cover).

The position fixing mechanism includes a coupling pin 46 that is connected through a leaf spring 48 with the guide rail side end of the second lever 34 via the guide element 36 thereof. The coupling pin 46 is part of a locking nose 49 that protrudes downward and latches in place in a recess 50 in the guide rail 18 when the sliding roof is in its closed position (see FIGS. 2 and 3). If so, the carriage 24 has assumed a front position, and both the first and second levers 30, 34 have a more or less horizontal orientation. With regard to FIG. 3, the joining axle 28 is at a left end of the elongated hole 32 and in a lower portion of the slot 26.

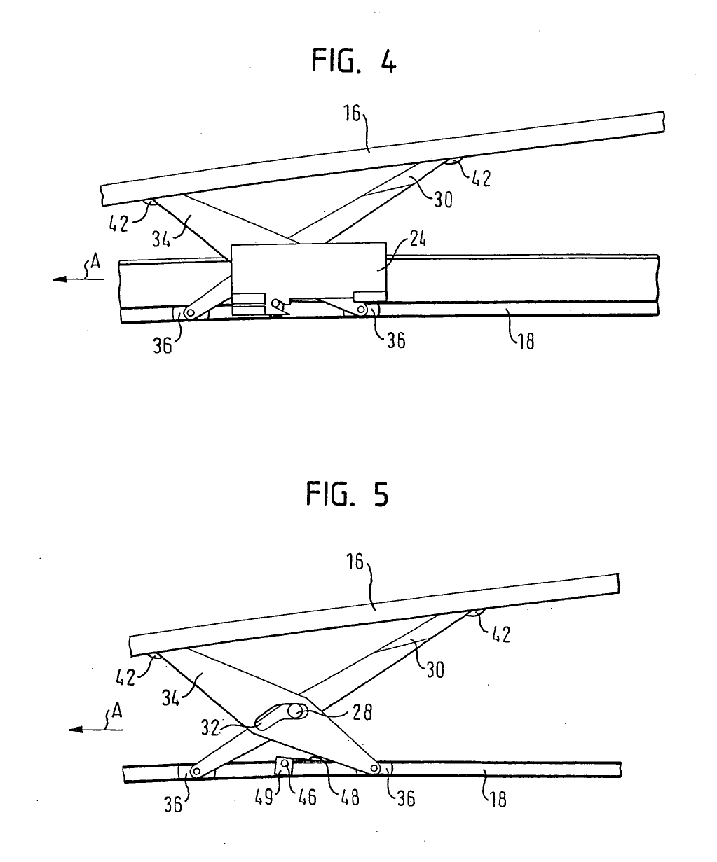

To raise the sliding roof, the carriage 24 is moved towards the rear by the shifting mechanism, so that the joining axle 28 travels to the left along the horizontal, lower portion of the slot 26 (FIG. 8) until the carriage 24 arrives at the portion that is directed obliquely upward. If there occurs a further displacement of the joining axle 28 in the slot 26 along the portion extending obliquely upwards, the first and second levers 30, 34 will deploy (see FIG. 4 and 5). The joining axle 28 continues to travel to the middle horizontal portion of the slot 26 and, in doing so, tilts the cover 16 to a larger extent. In the meantime, the guide rail side end of the second lever 34 is permanently held in position. During the entire raising motion, the carriage 24 exerts a force directly on the joining axle 28 to lift the latter and, thus, the first and second levers 30, 34.

At the end of the raising motion, a hook-shaped coupling slot 52 (see FIG. 8 and 9), which is provided on the carriage 24 and is directed obliquely upwards, reaches the coupling pin 46 and lifts the locking nose 49 against a force of the leaf spring 48 in order to uncouple the position fixing mechanism. With that, the unit of the first lever 30, the second lever 34 and the carriage 24 may now be moved to the rear by a maximum extent, until the unit reaches the end position in FIG. 6. As the unit of the first and second levers 30, 34 and the carriage 24 has a very compact construction in the longitudinal direction of the vehicle, the cover 16 can be moved very far towards the rear, resulting in a large opening width for the roof opening 14.

If the roof opening 14 is to be closed again, the carriage 24 is moved to the front again and in this process entrains the second lever 34 due to the oblique portion in the coupling slot 52, until the recess 50 is finally reached and the locking nose 49 latches in place in the recess 50 due to the force of the leaf spring 48. The carriage 24 will continue to move, so that the joining axle 28 travels to the lower, horizontal portion of the slot 26; in this process, the first and second levers 30, 34 will be swiveled downward to move the cover 16 to the closed position.

The position in which the locking nose 49 has just latched in place in the recess 50, is the so-called ventilation position of the cover 16. During traveling, the cover 16 reaches the zero position, i.e. a position in which the roof opening 14 is completely closed by the cover 16.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A raising mechanism for a sliding roof, comprising:
at least one lateral guide rail;
first and second levers, with each of the first and second levers having a guide rail side end and a cover side end, and both the first and second levers being pivotally coupled with each other through a joining axle; and
a carriage adapted to exert a vertical force on the joining axle and to lift the joining axle during traversing in order to move the first and second levers to a raised position.

2. The raising mechanism according to claim 1, wherein the joining axle comprises a bolt.

3. The raising mechanism according to claim 1, wherein the joining axle is arranged on the first lever.

4. The raising mechanism according to claim 1, wherein the second lever has a curved elongated hole that is engaged by the joining axle.

5. The raising mechanism according to any of claim 1, wherein the carriage has a slot that is engaged by the joining axle.

6. The raising mechanism according to claim 1, including a position fixing mechanism adapted to be selectively coupled with a vehicle-fixed part that is provided on the guide rail side end of one of the first and second levers, the position fixing mechanism temporarily fixing the guide rail side end of one of the first and second levers in one of a closed position and the raised position.

7. The raising mechanism according to claim 6, including a coupling mechanism that uncouples the position fixing mechanism from the carriage or couples the position fixing mechanism to the carriage for movement together with the carriage and which is able to engage with the vehicle-fixed part, respectively.

8. The raising mechanism according to claim 7, wherein the coupling mechanism has a coupling pin and a coupling slot.

9. The raising mechanism according to claim 8, wherein the coupling pin is associated to one of the first and second levers and the coupling slot is provided on the carriage.

10. The raising mechanism according to claim 9, wherein the coupling pin is connected with the one of the first and second levers through a leaf spring.

11. The raising mechanism according to claim 1, wherein the cover side end of each of the first and second levers is provided with a fork-like portion that engages with a cover.

12. The raising mechanism according to claim 1, wherein each of the first and second levers has a guide element at the guide rail side end, with each guide element being shiftable in the at least one lateral guide rail.

13. The raising mechanism according to any claim 1, wherein the sliding roof is a spoiler roof.

14. A sliding roof comprising:
a raising mechanism;
a cover adapted to open and close an opening in a vehicle roof; and
a carriage moveable along a longitudinal axis during opening and closing of the opening, the carriage being movable only between roof edges that extend transverse to the longitudinal axis.

15. The sliding roof according to claim 14, wherein the carriage substantially lies just within the opening that is limited by a surrounding edge of the vehicle roof.

16. The sliding roof according to claim 14, including a guide rail that movably supports the carriage, wherein the guide rail lies within the opening limited by a surrounding edge of the vehicle roof.
